(19) United States
(12) Patent Application Publication
(10) Pub. No.: US 2006/0213226 A1
(43) Pub. Date: Sep. 28, 2006

(54) Method and device for regulating the glass gob mass during the production of hollow glass containers

(76) Inventors: Thomas Hartmann, Buckeburg (DE); Manfred Krume, Porta Westfalica (FR); Dirk Winkelhake, Nienstadt (DE)

Correspondence Address: SYNNESTVEDT & LECHNER, LLP, 2600 ARAMARK TOWER, 1101 MARKET STREET, PHILADELPHIA, PA, 191072950, US

(21) Appl. No.: 10/564,899

(22) PCT Filed: Mar. 4, 2005
(86) PCT No.: PCT/EP05/02302

§ 371 Date: Jan. 17, 2006

(30) Foreign Application Priority Data
Mar. 10, 2004 (DE) 102004011647.4

(51) Int. Cl. C03B 9/41; C03B 5/26; C03B 17/00

(52) U.S. Cl. 65/29.11; 65/29.17; 65/129; 65/164

(57) ABSTRACT

The invention relates to a method and a device for controlling the glass gob mass in the production of hollow glass containers, wherein at least one plunger (2,2′) is disposed in a feeder head (3) and a changeable plunger movement profile is provided for the purpose of influencing the discharge of molten glass from the feeder head. For the simultaneous production of an assortment of hollow glass containers of a different weight, an IS glass forming machine which is used comprises for each section a changeable movement profile per plunger. A mass reference value difference is determined from a mass reference desired value and a mass reference actual value on the basis of at least one of consecutive gobs for each preform station. In dependence upon the mass reference value difference, the associated plunger movement profile for each preform station is changed in such a manner that by repeating the determination of the mass reference value difference and by changing the movement profile, the mass reference actual value is approximated stepwise to the mass reference desired value. In accordance with the invention, it is possible in a convenient manner to control the glass gob mass during the production of the assortment.

The invention relates to a method and a device according to the preamble of claim 1 and claim 11 respectively.

A generic method and a generic device are known in each case from EP 0 612 698 B1 and U.S. Pat. No. 6,272,885 B1. In the case of the known method and known device respectively, several plungers are provided which are each allocated to one of several gob outlets. This is intended to achieve the greatest possible degree of uniformity in the gobs which are output from the various gob outlets. To this end, a control system is provided which serves to monitor the vertical position of each plunger and which is used to control these vertical positions individually in dependence upon a measured gob weight. Each plunger is attached to an individual plunger holder which is connected in each case to a drive. However, in the case of this method and device respectively, there is no provision to produce an assortment of different hollow glass containers in an IS (Individual Section) glass forming machine. Therefore, in the case of the known device only a single movement profile is stored for each plunger. This can be corrected if required.

DE 100 18 270 A1 describes a device and a method for generating pressed glass articles, wherein two control circuits are used in relation to the stroke position and the temperature of the glass melt, in order to keep the gob weight constant.

U.S. Pat. No. 1,955,869 A describes a device for producing glass gobs which have a different weight. The lower dead center of the plunger can be altered by means of a displaceable stop which is disposed around the piston rod of the plunger and cooperates with a stop which is attached to the piston rod. Moreover, a change in the lower dead center can also be effected by introducing distance pieces between the displaceable stop and the fixed stop. Although the displaceable stop can also be adjusted by automatic means—as an alternative to a hand wheel—there is no disclosure in relation to the control by means of a stepwise approximation to the desired gob mass by means of a corresponding comparison of an actual value with a desired value. The same applies to the described, automatic introduction of distance pieces by means of a pneumatic piston-cylinder unit.

Furthermore, a feeder with a variable gob weight for container glass is known (“Electronic Feeder Type TSE” by the company J. Walter Co. Maschinen GmbH, 96352 Wilhelmsthal, Germany). In the case of this feeder which is suitable for the production of an assortment of hollow glass containers, four different gob weights can be produced consecutively. For example, two plungers are provided in the feeder head. A programmable plunger-movement profile can be modified manually by an operator using a graphical operating interface by changing support points. Equally, the stroke position of a plunger can be changed.

Furthermore, EP 0 668 248 A2 describes a device for the simultaneous production of glass articles of a different weight. In order to produce different gob weights, different movement profiles of the plunger are implemented. This can be achieved by changing reference positions which are stored in a storage unit and can be manually changed by means of a repositioning element. However, there is no disclosure in relation to the control of the glass gob mass.

It is also known per se from EP 0 873 974 A2 to modify a movement profile of a plunger manually by changing a support point of the movement profile, wherein an adaptation of interpolation sections affected by the support point change is performed automatically by computer control.

EP 1 266 869 A1 mentions in general terms the possibility of producing glass gobs of a different size by virtue of the fact that the plunger is controlled in its actuation in terms of time and also in its actuation path.

EP 1 422 200 A2 which was published after the priority date of the present application, relates to a device for the simultaneous production of glass products of a different mass, wherein provision is made to change various parameters of the movement profile of a plunger. However, this device also does not have any control over the gob mass.

It is known (e.g. from: off-print from “Siemens-Zeitschrift”, 51^{st} year, number 9, September 1977, pgs. 767-769), in order to guarantee a constant article weight, to provide a control device which is used to change the axial position of a restrictor pipe of the feeder head depending upon the weight or the mass of the formed article. The article weight can be determined e.g. by weighing. Alternatively, the article weight can also be controlled by measuring the insertion depth of a pressing plunger in the press-and-blow process (EP 0 652 854 B1). Changing the axial position of the restrictor pipe influences the height of the glass level inside the restrictor pipe and thus the glass volume exiting per feeder cycle or unit of time. In this manner, it is possible to compensate for disruptive influences, such as e.g. a change in glass viscosity or in the height level of the glass melt. A disadvantage of this restrictor pipe control circuit is, however, that it is relatively sluggish owing to the large inner volume of the restrictor pipe.

The movement profile of the plunger or of the associated plunger holder also has an influence upon the mass or contour of a gob which is output through the gob outlet. The rate at which the plunger is then removed from its lower end position has thus an influence. If the plunger or the plunger holder remains stationary in its lower end position for a relatively longer period of time, a lower article weight is produced because the plunger in its lower end position as a rule partially closes the cross-section of the gob outlet which is effective for the discharge of glass.

The above-described change in the position of the restrictor pipe is not suitable, by reason of the inertia associated with it, for producing an assortment of hollow glass articles of a different weight.

However, a manual adjustment of different consecutive movement profiles of the plunger with the objective of achieving a specific sequence of different gob weights is very difficult to achieve or cannot be achieved satisfactorily because the weight of each gob is influenced by the size of the previously output gobs, i.e. in other words it is dependent upon the “previous history” of the feeder operation. For example, during the production of a series of light gobs, the glass level in the feeder head will rise, if one or several relatively heavy gobs have been produced beforehand. The reason for this is that during the sequence of the lighter gobs, less glass flows out of the feeder head than during the preceding sequence of heavier gobs. This would result in different weights of the articles produced from the sequence of the lighter gobs, if a different plunger movement profile is not selected for each of the lighter, identical gobs. The more different the provided gob weights are in one machine cycle of an IS (Individual Section) glass forming machine or the less symmetry is in the weight sequence, the greater the problem is.

Therefore, it is the object of the invention to provide a generic method of controlling the glass gob mass which is suitable for the production of an assortment of hollow glass containers by means of an IS (Individual Section) glass forming machine. It is also the object of the invention to provide a generic device which is suitable for implementing this method.

The object in relation to the method is achieved by the features of claim 1. The assortment of hollow glass containers is produced simultaneously in the IS glass forming machine, i.e. within one machine cycle, hollow glass objects are produced in the individual sections and comprise at least in part different weights. For this purpose, each plunger has the same number of changeable movement profiles as there are sections. In this case, the location and speed of the plunger during its upwards and downwards movement are designated as the plunger movement profile. Therefore, the movement profiles of a sequence of movement profiles which are provided for each plunger and which are different according to the provided assortment of hollow glass containers are implemented consecutively.

If the feeder head which is used comprises several plungers, e.g. two or four, and correspondingly many gobs are generated per feeder cycle which are each guided into the same section, the same size gobs are generally provided per section. That is to say that in this case although the movement profiles of several plungers provided are different for the same section, the movement profiles are configured in such a manner that they produce gobs which have the same mass.

In the case of an IS glass forming machine, in which only one gob is processed in each case per section, a measured respective gob mass reference actual value and an associated gob mass reference desired value are compared by forming a mass reference value difference. These three values are variables which are directly related to the gob mass. In particular, they can be the actual mass value, the desired mass value and a mass difference which is calculated from these two values. The mass reference value difference is preferably determined from an individual gob. However, it could also be determined by several consecutive gobs of the section by using a mean value of the consecutive gobs as a mass reference actual value, in order in this way to smooth out any possible freak values of the mass reference actual value. If several gobs are processed in each section simultaneously in several preform stations in the IS glass forming machine, the mass reference value difference is determined for each preform station of the section.

In dependence upon the thus determined mass reference value differences, the movement profiles of the plungers provided are changed for each section in such a manner that the respective mass reference actual value is approximated stepwise to the mass reference desired value, if for further feeder cycles the determination of the mass reference value difference and the subsequent change in the movement profile are performed anew in each case.

In the case of the method in accordance with the invention, the gob masses which are required for the production of an assortment of hollow glass containers can be automatically optimized by the ignition sequence separately for each section and in the case of multiple gob operation also for each preform station of the section. This can occur dynamically particularly during the ongoing process. The method can be used for all numbers of gobs typical in practice for each scissor cut.

For each section, a check is carried out preferably after each completed machine cycle to verify whether a change is required to the at least one plunger movement profile of the section. In particular, within this checking procedure it is possible to verify whether the mass reference value difference is above a predetermined threshold value and if this is the case the associated movement profile is adapted. After a few machine cycles, the desired sequence of gob masses is achieved.

Several parameters of the plunger movement profile can be adjusted and managed separately or in combination with one another. The parameters include in particular the period of time the plunger is at a standstill in its lower and/or upper end position, the duration of the downwards and/or upwards movement of the plunger, the speed structure of the downwards and/or upwards movement of the plunger, the plunger stroke and the position of the plunger stroke relative to an orifice ring and thus to gob outlets of the feeder head. In particular, a change in the period of time the plunger is at a standstill in its lower end position and a change in the lower end position can be combined with one another.

For example, an extension to the period of time the plunger is at a standstill in its lower end position produces a reduction in the gob mass because the plunger in this end position partially closes the effective cross-section of the gob outlet. In the event the plunger stroke remains constant, a change in the duration of the downwards and/or upwards movement of the plunger, i.e. the plunger rate, will influence the frequency of the output of gobs from the feeder head, wherein an increase in this frequency is associated with a reduction in the gob mass. With the position of the plunger stroke, the lower end position of the plunger is changed, thus influencing the effective cross-section of the gob outlet. During the upwards movement of the plunger from its lower end position, a suction effect occurs upon the viscous glass. As a consequence, a certain portion of the molten glass is then drawn away from the gob outlet. This suction effect is particularly significant, if for a dual gob operation a single plunger is provided which cooperates with two gob outlets. By virtue of the relatively large diameter of the individual plunger, a high suction effect is exerted upon the viscous glass. The rate at which the plunger is moved downwards close to its lower end position has also an influence on the quantity of the glass discharged through the gob outlet.

A substantially horizontally extending plunger holder can be provided, to which all of the plungers provided in the feeder head are jointly attached. Alternatively, it can also be provided that each plunger is attached in its own right to a substantially horizontally extending plunger holder of this type and each plunger holder comprises its own drive. In order to implement in practical terms each plunger movement profile which is provided, provision can be made in particular for each plunger movement profile to be determined by a data record for an associated movement profile of the plunger holder. If several plungers are provided and these are attached to the same plunger holder, an individual data record for a movement profile of the plunger holder will be used at the same time to determine a respective movement profile of each plunger. This can be a complete determination or even a partial determination, namely if the plungers can be adjusted relative to each other in their axial position. This will generally be the case, wherein the axial position of one of the plungers cannot be changed, whereas the remaining plungers can be adjusted relative to the fixed plunger. In this case, provision is preferably made to provide a data record for a profile for moving the plunger relative to its plunger holder in addition to providing the respective data record for the plunger holder for each adjustable plunger. The desired movement profile of each plunger is produced by the superpositioning of the movement of the plunger holder and a possible adjustment movement of the plunger relative to its plunger holder. This superpositioning is effected in practical terms by processing both data records.

In addition to the described control of the plunger movement, it is also possible to control the axial position of the restrictor pipe of the feeder head, in order e.g. to compensate for the effects of changes in viscosity in the molten glass or of changes in the glass level in the feeder head upon the weight of the glass containers to be produced. In this case, it can be provided that a uniform difference proportion, which is provided over the entire machine cycle, between the mass reference actual values and the mass reference desired values is not taken into consideration in the control of the plunger movement profiles. This is based upon the fact that a gob mass deviation which is attributed to a change in the viscosity or glass level develops relatively slowly and therefore can be considered to be constant essentially over one machine cycle. Therefore, as long as the mass reference value difference is uniform over an entire machine cycle, it is eradicated by the vertical adjustment of the restrictor pipe, whereas fluctuations which occur in relation to an individual preform station are controlled as part of the procedure of changing the plunger movement profiles.

In order to identify whether the entire mass of all gobs of a machine cycle is too high or too low, a real mean value of the mass reference value differences of all gobs of a machine cycle is formed. If this real mean value which can also assume a negative value is different to zero, the axial position of the restrictor pipe is adjusted accordingly, so that the real mean value of the mass reference value differences at least virtually assumes the value zero. In order also to minimize in each case the mass reference value differences of the individual gobs which are guided consecutively to a same preform station, one or several parameters of the movement profile of the particular plunger which has produced the gobs is/are changed. However, the change to the plunger movement profiles is performed on the basis of scaled mass reference value differences. These have been produced under the proviso that they have a “fictitious” mean value of zero.

In this way, the restrictor pipe control circuit and the plunger control circuit influence each other to the least possible extent.

In terms of process engineering, it can be practical, particularly in the case of vastly different preform profiles or press plunger diameters in the assortment, to use substantially different plunger movement profiles for light hollow glass containers within the assortment than for heavy hollow glass containers, in order thereby to achieve a different gob contour in each case.

The determination of the mass reference actual value or the mass directly can be performed in a press-and-blow process by detecting the position of a pressing plunger in a preform station at the end of the pressing stroke. The reason for this is that this position correlates directly with the mass of the gob which has entered the preform station. A suitable displacement transducer for detecting the axial position of the pressing plunger can operate in particular on the basis of an inductance change, wherein the pressing plunger is mounted on a piston rod of a piston-cylinder unit and an annular coil which is fixed relative to the cylinder cooperates with a metal actuating element, which is mounted on the piston, for the purpose of changing the inductance of the coil in dependence upon the axial relative position of the piston and of the cylinder. The displacement transducer is preferably a displacement transducer in accordance with EP 0 652 854 B1.

In the case of the blow-and-blow process, the mass of the cut gobs can be determined on the basis of a capacitance change which the respective gob causes if it falls through between two capacitor plates. In particular, the method or the device in accordance with DE 101 33 019 C1 can be utilized. The respectively measured gob masses or weights are stored in the order of the ignition sequence and are compared with a desired mass reference or weight value which can be adjusted separately for each preform station.

In relation to the device, the object is achieved by the features of claim 11. The device comprises at least one plunger having means for effecting upwards and downwards movement. Furthermore, the device contains a control unit, in which for each section of an IS glass forming machine it is possible to store a changeable movement profile for each plunger. In contrast to the devices in accordance with EP 0 612 698 B1 and U.S. Pat. No. 6,272,885 B1, several changeable movement profiles can be stored simultaneously in the control unit for each plunger, e.g. eight movement profiles for eight sections. These movement profiles are implemented consecutively in a specific sequence. Furthermore, means are provided to determine a mass reference value difference, as described above, from one or several consecutive gobs for each preform station of each section. The control unit which is connected via a data line to the means for determining the mass reference value difference, is designed in such a manner that it is able to change for each section the plunger movement profile or for several preform stations the plunger movement profiles in dependence upon the determined mass reference value difference, such that by repeating the determination of the mass reference value difference with subsequent change to the movement profile for further feeder cycles the respective mass reference actual value is approximated stepwise to the mass reference desired value.

Preferred embodiments of the device are described in claims 12 to 17.

The advantages which are described above in conjunction with the method in accordance with the invention apply correspondingly to the device in accordance with the invention.

The invention will be explained in detail hereinunder with reference to exemplified embodiments, wherein reference is made to the Figures, in which:

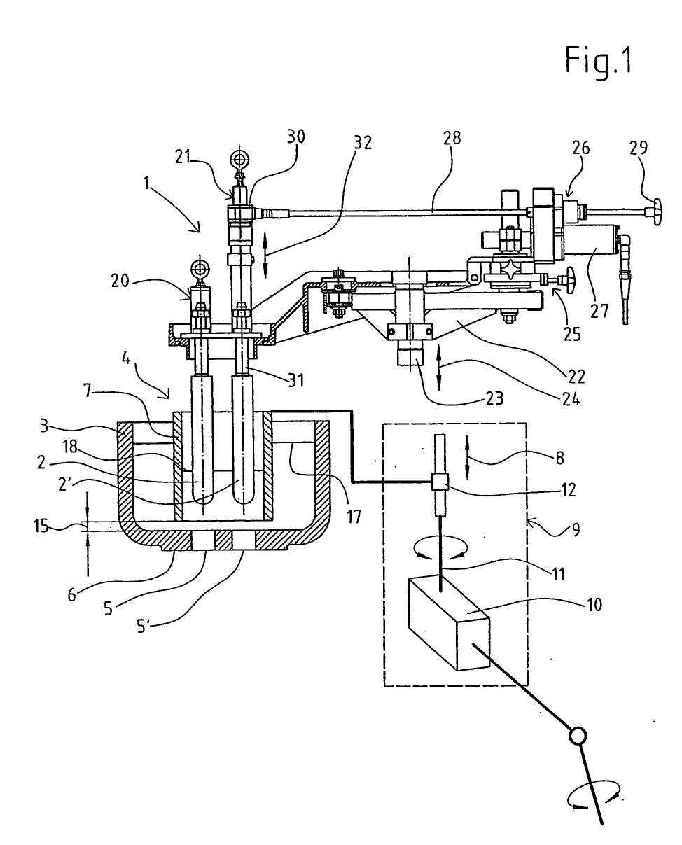

FIG. 1 schematically shows a device for controlling the glass gob mass in the production of hollow glass containers by means of an IS glass forming machine,

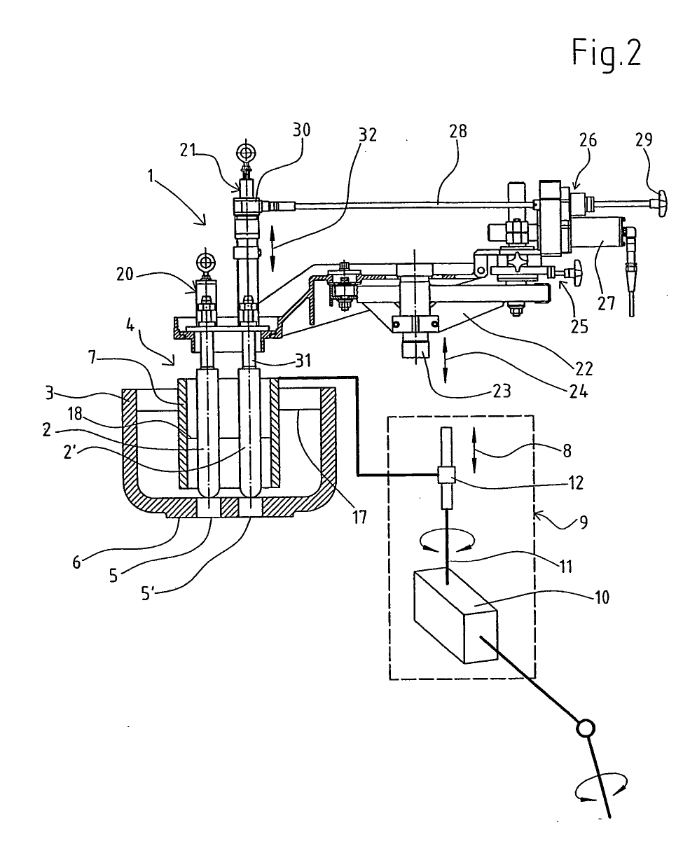

FIG. 2 shows the device of FIG. 1 in a different operating position,

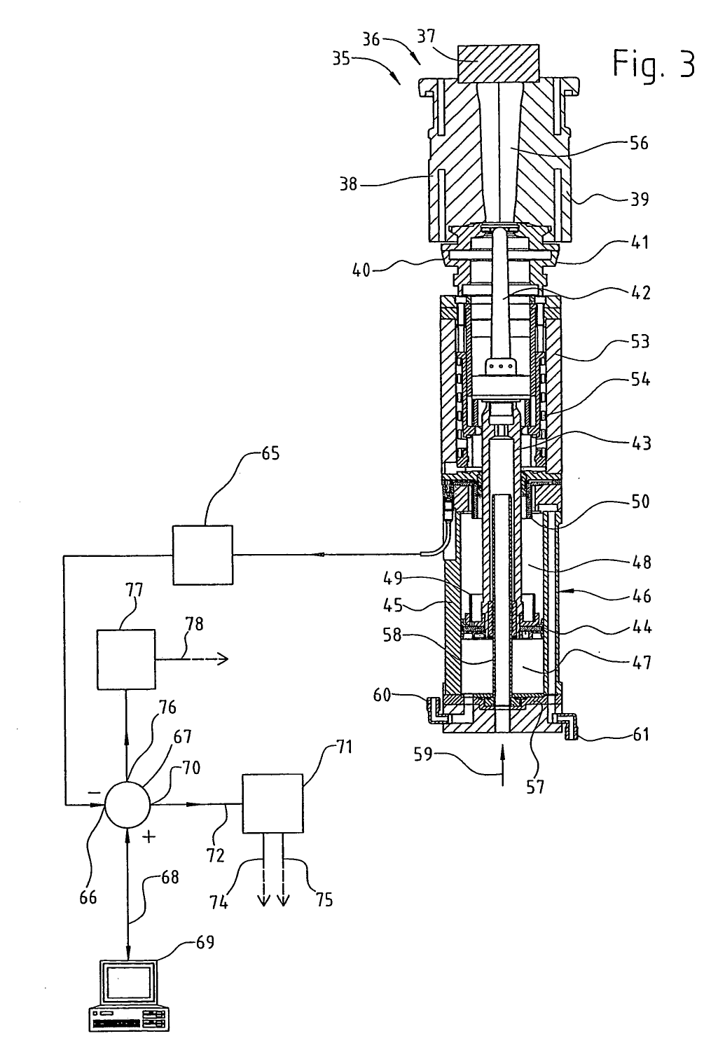

FIG. 3 shows a longitudinal sectional view of a pressing plunger mechanism having a closed preform and an associated block diagram for determining a mass difference,

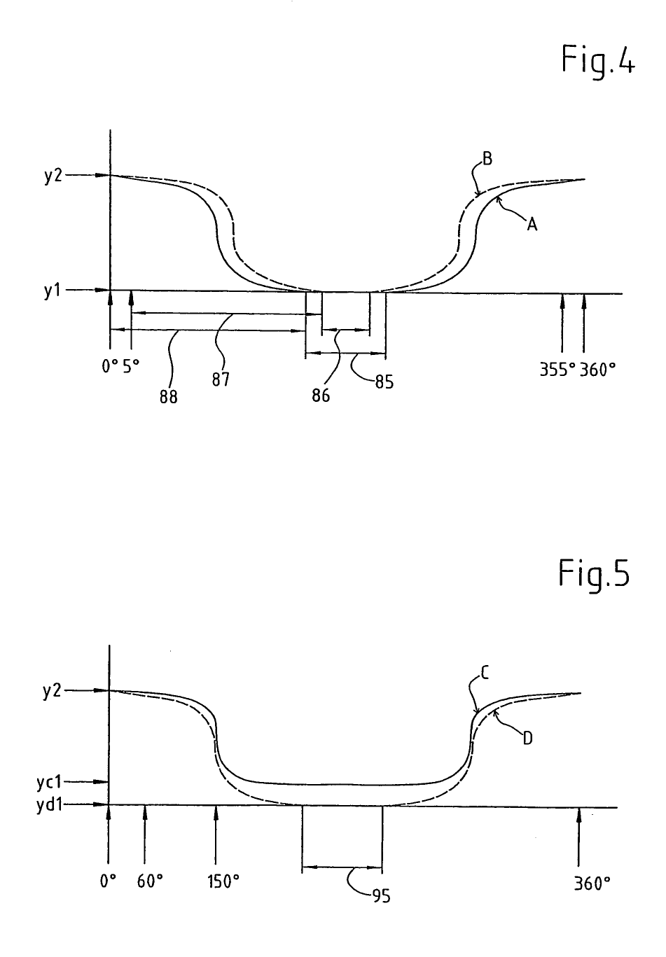

FIG. 4 shows two different movement profiles for a plunger holder,

FIG. 5 shows two further different movement profiles for a plunger holder,

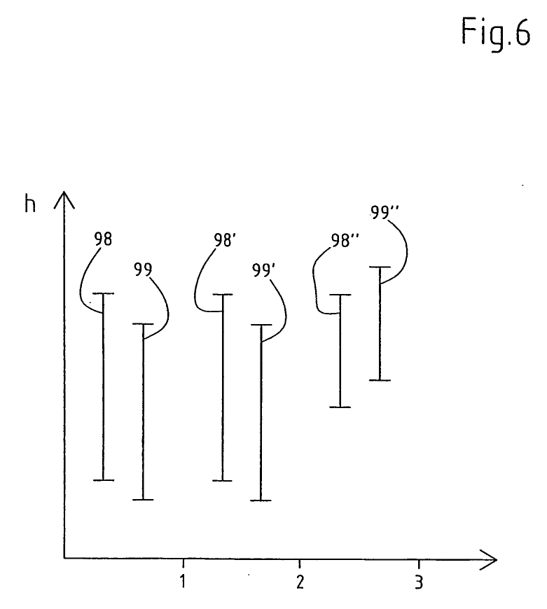

FIG. 6 shows the position of two plunger strokes over several feeder cycles.

The device for controlling the glass gob mass as shown in FIG. 1 is designated by the reference numeral 1. The device 1 comprises two plungers 2 and 2′. The plungers 2, 2′ are disposed in a feeder head 3 of a feeder 4. The feeder head 3 comprises a dual gob outlet which is formed by two openings 5 and 5′ in an orifice ring 6. Furthermore, the feeder head 3 comprises a restrictor pipe 7 which surrounds the two plungers 2, 2′. The axial position of the restrictor pipe 7 serving as the control variable can be changed in a manner which is know per se as shown by the double arrow 8. A drive 9 of the restrictor pipe 7 is shown in a schematic and only partial manner in FIG. 1. In order to adjust the vertical position of the restrictor pipe 7, a motor is provided, not shown, which drives a spindle 11 via an angular gear mechanism 10. The spindle 11 cooperates with a spindle nut 12 which is connected to the restrictor pipe 7. Furthermore, a mechanism, not shown, can be provided in order to be able to adjust the restrictor pipe 7 horizontally with respect to the symmetrical arrangement around the dual gob outlet 5, 5′ horizontally [sic]. By virtue of the vertical adjustment indicated by the double arrow 8, a gap 15 is adjusted between a lower end of the restrictor pipe 7 and the orifice ring 6.

Molten glass is located in the feeder head 3. The glass level outside the restrictor pipe 7 is designated by the reference numeral 17, whereas the glass level inside the restrictor pipe is designated by the reference numeral 18. The glass level 18 depends upon the glass level 17 and upon the size of the gap 15. The glass level 18 ultimately determines the glass volume exiting the openings 5, 5′ per unit of time or per feeder cycle. By virtue of a vertical adjustment of the restrictor pipe 7 as indicated by the double arrow 8, it is thus possible in particular to compensate for a change in the glass level 17 or a change in the viscosity of the molten glass over a period of time which is relatively long in comparison with the duration of a feeder cycle.

The plungers 2, 2′ are each attached to a plunger holder 22 by fastening means 20, 21. The plunger holder 22 is attached to a support column 23 which can be moved vertically up and down, as indicated by the double arrow 24. The drive mechanism for the support column 23, which is not shown, can be e.g. the drive mechanism in accordance with DE 203 16 501 U1. The plunger holder 22 comprises means 25 for performing basic horizontal adjustment.

While the height of the plunger 2 relative to the plunger holder 22 is fixed, the height of the plunger 2′ relative to the plunger holder 22 can be changed by means of a height adjusting device 26. The height adjusting device 26 comprises a motor-gear unit 27 which drives a shaft 28. A hand wheel 29 allows the shaft 28 to be rotated manually. The shaft 28 acts upon a guide element 31 of the fastening means 21 via a worm gear 30, in order to move the plunger 2′ as indicated by the double arrow 32.

In FIG. 2, both plungers 2, 2′ are shown in a lower end position. In this case, this relates to a lower end position which is associated with a specific movement profile of a series of different movement profiles of the plungers 2, 2′.

FIG. 3 shows a preform station 35 of a section 36 of an IS glass forming machine. The preform station 35 comprises a preform base 37, preform halves 38 and 39, neck ring halves 40 and 41 and a pressing plunger 42. The pressing plunger 42 is attached in a manner known per se to the upper end of a piston rod 43 of a piston 44. The piston 44 is displaceable in a cylinder 45 of a piston-cylinder unit 46. Located below the piston 44 is a forward feed chamber 47 and located above the piston 44 is a retraction chamber 48. The piston 44 has an actuating ring 49 for a pressing plunger position sensor 50 which in this case is formed in accordance with EP 0 652 854 B1.

The pressing plunger 42 is guided through a guide cylinder 53 which is coaxial with respect to the cylinder 45. Moreover, the guide cylinder 53 is provided with a spring 54 which in the event of a ventilated forward feed chamber 47 and ventilated retraction chamber 48 moves the pressing plunger 42 to its axial loading position illustrated in FIG. 3. In this loading position, an upper tip of the pressing plunger 42 enters just into an opening region of a preform recess 56. In the loading position, the preform base 37 is initially removed, so that from the top a glass gob is able to fall into the preform recess 56 and onto the tip of the pressing plunger 42.

The piston rod 43 is formed in a hollow manner and receives a cooling air pipe 58 which is attached to a base 57. The cooling air pipe 58 is supplied with cooling air for the pressing plunger 42 in the direction of an arrow 59.

A connection for introducing air into and removing air from the forward feed chamber 47 is designated by the reference numeral 60, a connection for introducing air into and removing air from the retraction chamber 48 is designated by the reference numeral 61. Further means for introducing air into and removing air from the forward feed chamber 47 and the retraction chamber 48 for performing a pressing cycle of the pressing plunger 42 are not shown. In particular, the means provided can be those in accordance with the German patent application 103 16 600.9.

The pressing plunger position sensor 50 is connected via a signal amplifier/signal evaluating unit 65 to a signal input 66 of a control circuit 67 implemented in software. The control circuit 67 is also connected bi-directionally to an input/output unit 69 via a line 68. A signal output 70 of the control circuit 67 is connected by means of a line 72 to a common drive controller 71 for the plunger holder 22 and the height adjusting device 26.

By means of the pressing plunger sensor 50, a position signal is generated which provides a statement relating to the size of the maximum insertion depth of the pressing plunger 42 into the mold tool. The greater the maximum insertion depth, the smaller the gob mass which has entered into the preform recess 56. The measured pressing plunger end position is transmitted by the signal amplifier/signal evaluating unit 65 to the control circuit 67. The control circuit 67 compares the measured pressing plunger end position with a desired value for the pressing plunger end position which has been input to the control circuit 67 via the input/output unit 69. The desired values of the pressing plunger end position can be adjusted separately for each preform station 35 of the IS glass forming machine.

The deviation obtained therefrom between the desired value and the actual value of the pressing plunger end position is converted into a mass difference or weight difference with consideration given to the known cross-sectional area of the pressing plunger 42. This mass difference is transmitted via the signal output 70 to the drive controller 71. In the drive controller 71, a real mean value of the mass differences of all gobs of a machine cycle is formed. A stepwise change in the axial position of the restrictor pipe 7, preferably in each case between two machine cycles ensures that this real mean value at least virtually assumes the value zero. If this is achieved, the gobs of a machine cycle viewed in total have the desired total mass but the individual gobs will not have the desired mass value. In order to achieve this, the determined mass differences of the individual gobs are used according to a scaling, in order to change one or several parameters of the movement profile of the particular plunger which has produced the gob. The scaling is performed in such a manner that the scaled mass differences with a correctly signed addition produce a “fictitious” mean value of zero over a machine cycle. In this manner, the restrictor pipe control circuit and the plunger control circuit are connected quasi in series.

The drive controller 71 is connected via a signal line 74 to a motor, not shown, of the drive mechanism for the support column 23. Furthermore, the drive controller 71 is connected via a signal line 75 to the step motor-gear unit 27 of the height adjusting device 26 which acts upon the plunger 2′.

A further signal output 76 of the control circuit 67 is connected to a restrictor pipe-drive controller 77. A signal line 78 leads from the restrictor pipe-drive controller 77 to the drive 9 of the restrictor pipe 7.

It is necessary to provide the same number of plunger movement profiles as there are preform stations 35 in the IS glass forming machine. Since the device 1 as shown in FIGS. 1 and 2 comprises a feeder head 3 with a dual gob outlet, it is provided that two gobs which are each processed in one of two preform stations 35 of the respective section enter simultaneously into each section of the IS glass forming machine. For example, the IS glass forming machine can be an 8-DG machine which thus comprises eight sections and processes sixteen gobs within one machine cycle. It can also be provided that the two gobs which enter simultaneously into a section shall have the same mass. An assortment which is relatively easy to produce can comprise two different types of hollow glass containers, namely a light hollow glass container and a heavy hollow glass container. In this case, it can be provided that over the ignition sequence of a machine cycle a heavy gob is followed by a light gob which is then followed by a heavy gob and so on and so forth.

In the case of the above embodiment of the method or the device, eight data records for eight movement profiles of the plunger holder 22, i.e. for the eight feeder cycles of a machine cycle are stored in the drive controller 71. However, since only two different gob masses are to be produced alternately, four movement profiles or data records will be identical after completion of an adjustment procedure which generally extends over only a few machine cycles, so that alternately the plunger holder 22 always only executes two movement sequences.

FIG. 4 illustrates these two plunger holder movement profiles by the letters A and B. Plotted on the x-axis is the sequence of a feeder cycle, wherein the beginning and the end of a feeder cycle are defined by 0° and 360° respectively. Plotted on the y-axis is the vertical position the plunger holder 22, wherein y1 designates a lower end position of the plunger holder 22 and y2 designates an upper end position of the plunger holder 22. Since the duration of a feeder cycle is specified, the movement profiles A and B represent the location and time of the plunger holder 22 over a feeder cycle.

In the lower end position yl of the plunger holder 22, the movement profile A has a standstill period 85 which is longer than a corresponding standstill period 86 of the movement profile B. Since a longer standstill period of a plunger in its lower end position produces a smaller gob mass, the movement profile A is provided for the sections of the IS glass forming machine which are used for the purpose of producing the lighter hollow glass containers, whereas the movement profile B is provided for the purpose of producing the gobs for the heavier hollow glass containers. Furthermore, in comparison with the movement profile B, the movement profile A has a shorter standstill period in the upper end position y2. In accordance with movement profile B, the plunger holder 22 remains between about 355° and 5° in its upper end position y2. However, the duration 87 of the downwards movement in accordance with movement profile B is virtually the same as the duration 88 of the downwards movement in accordance with movement profile A. The same applies to the upwards movements in accordance with movement profiles A and B, since the downwards and upwards movements of the movement profile A and B are symmetrical with respect to each other. In the case of the movement profile A, the standstill period 85 in the lower end position y1 is longer than the standstill period in the upper end position y2 which is almost zero.

The two movement profiles A and B are achieved by means of stepwise approximation starting from in each case an initial movement for the movement profile A or movement profile B, in that after completion of a machine cycle the determination of the mass difference is performed for each gob which is produced within the machine cycle and a corresponding change in the associated movement profile of the plunger holder 22 is carried out. This approximation method is completed, if the actual mass values are sufficiently close to the respective desired mass value, i.e. the measured mass difference does not exceed a specified threshold value. The approximation method generally only requires several machine cycles.

FIG. 5 illustrates two further movement-profiles C and D of the plunger holder 22 which are likewise to be used for an assortment as described in conjunction with FIG. 4. The movement profiles C and D differ from the movement profiles A and B primarily due to the fact that they describe different strokes of the plunger holder 22. The stroke of the movement profile C is the spaced interval between a lower end position yc1 and an upper end position y2 of the plunger holder 22. Whereas the upper end position of the plunger holder 22 in accordance with movement profile D is likewise y2, a lower end position yd1 is lower than in the case of movement profile C. The movement profile C effects the output of the heavier gobs from the feeder head 3, the movement profile D on the other hand effects the output of the lighter gobs. The reason for this is that the respective lower end position yc1 or yd1 serves to influence the free cross-section of the openings 5, 5′.

A standstill period 95 of the plunger holder 22 in its lower end position yc1 or yd1 is identical in the case of the two movement profiles C and D. Furthermore, the movement profile C differs from the movement profile D by virtue of the speed structure of the downwards and upwards movement. For example, this different speed structure is shown between 60° and 150° and correspondingly in the upwards movements of the movement profiles C and D which are symmetrical thereto.

The parameters described or even further parameters of the plunger holder movement profiles can be changed for the purpose of producing a desired gob size or gob contour. In particular, the rate at which the plunger holder 22 is moved downwards or upwards close to its lower end position can be varied. When the glass is very viscous a certain portion of the glass is then drawn back during the upwards movement.

Whereas in the above-described situations as shown in FIGS. 4 and 5, an assortment is to be produced with only two different article weights and in an alternating sequence in the ignition sequence, it can also be possible for example that although the assortment includes only two different article weights, it is intended in a sequence of eight feeder cycles of an 8-DG machine to produce initially two heavy gob pairs (e.g. 168 g per gob) and then 5 light gob pairs (e.g. 160 g per gob) and subsequently to produce another heavy gob pair. The sequence of the five light gob pairs on the run ensures that the glass level 18 inside the restrictor pipe 7 rises increasingly during the period of the sequence, as less glass flows out. Without a corresponding control procedure, the gob pairs would have different masses within this light sequence. The same would be true for a heavy sequence. The method and device in accordance with the invention render it possible within a short period of time to control the desired masses of the gobs, in that for each gob which is produced an associated plunger movement profile is adjusted.

It is possible for the movement profiles of the plungers 2, 2′, when viewed relatively, to correspond with the movement profile of the plunger holder 22. This is particularly the case if a controlled adjustment of the plunger 2′ relative to the plunger 2 is not provided. However, this type of adjustment of the plunger 2′ can be required by reason of undesired slight differences between the openings 5, 5′, in order to ensure that the two gobs which have been output from the openings 5, 5′ and enter into the same section are the same size. In general terms, this is something which is desired. If this is required for this purpose, the plunger 2′ is adjusted from feeder cycle to feeder cycle by the height adjusting device 26 which is controlled by the drive controller 71. This movement of the fastening means 21 or the additional movement of the plunger 2′ is superimposed on to the movement of the plunger holder 22, so as to produce from this the resultant movement of the plunger 2′. In the example of an 8-DG machine as described above, a further eight movement profile data records for the height adjustment device 26 are stored in the drive controller 71 in addition to the eight movement profile data records for the plunger holder 22.

In FIG. 6, the strokes of the two plungers 2 and 2′ are illustrated over three consecutive feeder cycles (x-axis). The vertical axis h represents the relative height of the respective lower end of the plunger 2, 2′ over the orifice ring 6. The lines 98, 98′ and 98″ are used to illustrate the strokes of the plunger 2 and their position during three consecutive feeder cycles. Furthermore, the strokes of the plunger 2′ and their position for the three feeder cycles are shown by the lines 99, 99′ and 99″. The plunger strokes 98 and 99 are identical, i.e. the maximum excursions of the plungers 2 and 2′ are the same because the plungers 2, 2′ are attached to the same plunger holder 22. However, the position of the plunger strokes 98 and 99 is different, in order to compensate for slight differences in the size of the openings 5, 5′ so that a pair of identical size gobs is produced in the feeder cycle. To this end, the plunger 2′, unlike the illustrations in FIGS. 1 and 2, is attached to the plunger holder 22 at a slightly lower position than the plunger 2. The plunger strokes 98 and 99 are thus determined exclusively by the stroke movement of the plunger holder 22.

During the second illustrated feeder cycle, the plungers 2 and 2′ comprise the strokes 98′ and 99′. These are unchanged with respect to the first feeder cycle illustrated, and the same goes for their position, as in the example illustrated in FIG. 6, the approximation method is already completed and therefore a desired equilibrium has been achieved in relation to the gob masses and it is intended to produce identical gob masses during the first and the second feeder cycle illustrated.

In contrast, for the third illustrated feeder cycle it is intended to produce a larger gob mass. To this end, smaller plunger strokes 98″ and 99″ are produced, in that the plunger holder 22 in accordance with an associated data record performs a correspondingly reduced stroke. In so doing, the lower end positions of the plungers 2 and 2′ are located at a larger spaced interval with respect to the openings 5, 5′ than in the two previous feeder cycles. The aforementioned slight differences in the openings 5, 5′ make it necessary in the third illustrated feeder cycle to displace the plunger 2′ upwards in its vertical position, in order also to produce a pair of identical size gobs in the third illustrated feeder cycle. This displacement of the plunger 2′ is effected by virtue of a corresponding adaptation of the data record by means of the height adjusting device 26, and furthermore preferably when the plunger 2′ is located in the region of its upper end position. For the sake of clarity, the dynamics of the change in the stroke position of the plunger 2′ are not illustrated in FIG. 6.

1. Method of controlling the glass gob mass in the production of hollow glass containers by means of a glass forming machine (36), wherein at least one plunger (2,2′) is disposed in a feeder head (3) of a feeder (4) and in order to move the at least one plunger (2,2′) vertically upwards and downwards a movement profile (A,B,C,D) is provided which can be changed in order to influence the discharge of molten glass from the feeder head (3),
characterized in that the glass forming machine is an IS (Individual Section) glass forming machine (36) and for the simultaneous production of an assortment of hollow glass containers of a different weight a changeable movement profile (A,B,C,D) for each plunger (2,2′) is provided for each section (36) of the IS glass forming machine,
a mass reference value difference is determined from a mass reference desired value and a measured mass reference actual value on the basis of at least one of consecutive gobs for each preform station (35) of each section (36),
in dependence upon the determined mass reference value difference for each preform station (35) the associated plunger movement profile (A,B,C,D) is changed in such a manner that by virtue of subsequent repetition of the determination of the mass reference value difference with subsequent change to the movement profile (A,B,C,D) the mass reference actual value is approximated stepwise to the mass reference desired value.

2. Method as claimed in claim 1,
characterized in that after each completed machine cycle a check is carried out for each preform station (35) to verify whether the mass reference value difference is above a threshold value and if this is the case the plunger movement profile (A,B,C,D) is adapted for the preform station (35).

3. Method as claimed in claim 1,
characterized in that the standstill period (85,86) of the plunger (2,2′) is changed in its lower (y1;yc1,yd1) and/or upper (y2) end position.

4. Method as claimed in claim 1,
characterized in that the duration (87,88) of the downwards and/or upwards movement of the plunger (2,2′) is changed.

5. Method as claimed in claim 1,
characterized in that the speed structure of the downwards and/or upwards movement of the plunger (2,2′) is changed.

6. Method as claimed in claim 1,
characterized in that the plunger stroke (98,98′,98″,99,99′,99″) is changed.

7. Method as claimed in claim 1,
characterized in that the position (98,98′,98″,99,99′,99″) of the plunger stroke relative to an orifice ring (6) of the feeder head (3) is changed.

8. Method as claimed in claim 1,
characterized in that at least one substantially horizontally extending plunger holder (22) is provided and each plunger movement profile is determined by a data record for an associated movement profile (A,B,C,D) of the plunger holder (22).

9. Method as claimed in claim 8,
characterized in that in the presence of several plungers (2,2′) for each section (36), in addition to the respective data record for the plunger holder (22) or the data records for the plunger holders (22), except for a first plunger (2), for each of the plungers (2′) a data record for a profile (99,99′,99″) is provided to move the plunger (2′) relative to its plunger holder (22).

10. Method as claimed in claim 1,
characterized in that if, in addition, the axial position of a restrictor pipe (7) of the feeder head (3) is regulated in order to compensate for the effects of changes in the viscosity of the molten glass or changes in the glass level (17, 18) in the feeder head (3) upon the mass of the glass containers to be produced, a real mean value is formed from the mass reference value differences of all gobs of a machine cycle and this mean value is approximated to the value zero by changing the axial position of the restrictor pipe (7) between two respective cycles and furthermore, the mass reference value differences are scaled in such a manner that a fictitious mean value of zero is produced from the scaled mass reference value differences and the change in the plunger movement profiles (A,B,C,D) is performed on the basis of the scaled mass reference value differences.

11. Device (1) for controlling the glass gob mass in the production of hollow glass containers by means of a glass forming machine (36), comprising at least one plunger (2,2′), which is disposed in a feeder head (3) of a feeder (4), and means (22,23,26) for moving the at least one plunger (2,2′) upwards and downwards, wherein a movement profile (A,B,C,D) for the plunger movement is stored in a control unit (71) of the device (1), said movement profile being changeable in order to influence the discharge of molten glass from the feeder head (3),
characterized in that the glass forming machine is an IS (Individual Section) glass forming machine (36) and for the simultaneous production of an assortment of hollow glass containers of a different weight a changeable movement profile (A,B,C,D) for each plunger (2,2′) can be stored in the control unit (71) for each section (36) of the IS glass forming machine,
the device (1) comprises means (67) to determine a mass reference value difference from a mass reference desired value and a measured mass reference actual value on the basis of at least one of consecutive gobs for each preform station (35) of each section (36),
and the control unit (71) is connected via a data line (72) to the means (67) for determining the mass reference value difference and is designed, in dependence upon the determined mass reference value difference for each preform station (35), to change the associated plunger movement profile (A,B,C,D) such that by virtue of subsequent repetition of the determination of the mass reference value difference with subsequent change to the movement profile (A,B,C,D) the mass reference actual value is approximated stepwise to the mass reference desired value.

12. Device as claimed in claim 11,
characterized in that the device (1) is designed, after each completed machine cycle to carry out a check for each preform station (35) to verify whether the mass reference value difference is above a threshold value and if this is the case, to adapt the plunger movement profile (A,B,C,D) for the preform station (35).

13. Device as claimed in claim 11,
characterized in that the device (1) is designed to change the plunger movement profiles (A,B,C,D), by changing one parameter or several parameters in combination with each other from the group consisting of standstill period (85,86) of the respective plunger (2,2′) in its lower (y1;yc1,yd1) and/or upper (y2) end position, duration (87,88) of the downwards and/or upwards movement of the plunger (2,2′), speed structure of the downwards and/or upwards movement of the plunger (2,2′), plunger stroke (98,98′,98″,99,99′,99″) and position (98,98′,98″,99,99′,99″) of the plunger stroke relative to an orifice ring (6) of the feeder head (3).

14. Device as claimed in claim 11,
characterized in that the device (1) comprises at least one substantially horizontally extending plunger holder (22) and each plunger movement profile is determined by a data record, which is stored in the control unit (71), for an associated movement profile (A,B,C,D) of the plunger holder (22).

15. Device as claimed in claim 14,
characterized in that all of the plungers (2,2′) are jointly attached to a plunger holder (22) and the control unit is a drive controller (71) of the plunger holder (22).

16. Device as claimed in claim 14,
characterized in that the device (1) comprises several plungers (2, 2′) and for each section (36) in addition to the respective data record for the plunger holder (22) or the data records for the plunger holders (22), except for a first plunger (2), for each of the plungers (2′) a data record for a profile (99,99′,99″) to move the plunger (2′) relative to its plunger holder,(22) by means of a height adjusting device (26) can be stored in an associated drive controller (71).

17. Device as claimed in claim 11,
characterized in that if, in addition, a control circuit for the axial position of a restrictor pipe (7) of the feeder head (3) is provided for the purpose of compensating for the effects of changes in the viscosity of the molten glass or of changes in the glass level in the feeder head (3) upon the mass of the glass containers to be produced, the device (1) is designed to form a real mean value from the mass reference value differences of all gobs of a machine cycle and to approximate this mean value to the value zero by changing the axial position of the restrictor pipe (7) between two respective machine cycles and furthermore to scale the mass reference value difference in such a manner that a fictitious mean value of zero is produced from the scaled mass reference value differences, and to perform the change in the plunger movement profiles (A,B,C,D) on the basis of the scaled mass reference value differences.
